(19) United States
(12) Patent Application Publication
(10) Pub. No.: US 2022/0004869 A1
(43) Pub. Date: Jan. 6, 2022

(54) EVENT PREDICTION DEVICE, EVENT PREDICTION METHOD, AND EVENT PREDICTION PROGRAM

(71) Applicant: NIPPON TELEGRAPH AND TELEPHONE CORPORATION, Tokyo (JP)

(72) Inventors: Maya OKAWA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/289,696

(22) PCT Filed: Oct. 29, 2019
(86) PCT No.: PCT/JP2019/042309

§ 371 Date: Apr. 28, 2021

(30) Foreign Application Priority Data
Nov. 1, 2018 (JP) 2018-206203

(51) Int. Cl. G06N 3/08

(52) U.S. Cl. CPC G06N 3/08

(57) ABSTRACT

An object is to predict an event with high accuracy by efficiently incorporating external information into a point process model of events. In an event prediction device 10 that predicts an event, an operation unit 3 extracts event history information from an event history storage device 1 and extracts external information from an external information storage device 2, the event history information including a point in time and a place at which an event has occurred, the external information including an external factor that affects the occurrence of an event. A parameter estimation unit 5 estimates an optimum parameter for prediction of an event by supplying the extracted history information and the extracted external information to learning of a relationship between the point process model of events and external factors.

### TECHNICAL FIELD

The present invention relates to a technology for predicting an event in the near future based on a history of the occurrence of events in time and space and external information that affects the probability of the occurrence of an event.

### BACKGROUND ART

Prediction of events has an important role in optimization of ride share systems, such as taxis, car sharing, and motorcycle sharing, and police patrolling.

For example, if future boarding events can be predicted in a car sharing system, it is possible to dispatch cars in advance to points in time and places at which the need for boarding is high. Event data is expressed as a sequence of events and is described using a model that is called a point process. Spatio-temporal point processes are widely used for modeling events spread in time and space. For example, self-exciting spatio-temporal point processes are proposed for modeling earthquakes (NPL 1).

However, with the above-described methods, external information cannot be taken into consideration. The probability of the occurrence of an event largely changes under the influence of an external environment. For example, taxi boarding events are affected by various external factors such as weather, a period, a road network, events (a concert, a sports event, etc.) held in a surrounding area, and road conditions. To achieve accurate prediction, external information including these external factors needs to be incorporated into a point process model.

As point process models in which external information is used, proportional hazard models and extension methods thereof are proposed (NPL 2). In these methods, external information is treated as a covariate of a point process model, and a function that expresses the influence of the covariate on the probability of the occurrence of an event is manually designed. However, in many cases, it is not clear how the influence of these external factors should be modelled.

### CITATION LIST

### Non Patent Literature

[NPL 1] Reinhart, Alex. “A review of self-exciting spatio-temporal point processes and their applications”, Statistical Science 33.3 (2018): 299-318.
[NPL 2] Cox, David R. “Regression models and life-tables”, Break throughs in statistics. Springer, New York, N.Y., 1992. 527-541.
[NPL 3] OGATA, Yoshihiko. “On Lewis” simulation method for point processes, IEEE Transactions on Information Theory, 1981, 27.1: 23-31.

### SUMMARY OF THE INVENTION

### Technical Problem

The above-described external information is acquired from a plurality of accumulated data sources. Each data piece of the external information is expressed by a high dimensional feature vector. For example, a road network is acquired as a map image and event information is acquired as a sequence of a natural language. It is not clear how such high dimensional data of different types affects the probability of the occurrence of an event. If a model that does not match the reality is selected, the accuracy of prediction is significantly reduced.

In view of the above circumstances, it is an object of the present invention to efficiently incorporate external information into a point process model of events and predict an event with high accuracy.

### Means for Solving the Problem

One aspect of the present invention is an event prediction device that predicts an event, including a parameter estimation unit configured to estimate an optimum parameter for prediction of an event by supplying event history information and external information to learning of a relationship between a point process model of events and external factors, the event history information including a point in time and a place at which an event has occurred, the external information including an external factor that affects the occurrence of an event.

Another aspect of the present invention is an event prediction method for predicting an event by using a computer, the method including estimating an optimum parameter for prediction of an event by supplying event history information and external information to learning of a relationship between a point process model of events and external factors, the event history information including a point in time and a place at which an event has occurred, the external information including an external factor that affects the occurrence of an event.

According to another aspect of the present invention, in the event prediction device and the event prediction method, the point process model is an intensity function that is expressed by a sum total of products of a kernel function and a deep learning model, position information regarding a representative point corresponding to the external information is supplied as a parameter of the kernel function, the position information regarding the representative point and the external information are supplied as parameters of the deep learning model, and the history information is supplied as a parameter of a likelihood function of the intensity function.

According to another aspect of the present invention, in the event prediction device and the event prediction method, the optimum parameter is a parameter of the deep learning model with which a likelihood computed using the likelihood function becomes the maximum.

Note that in another aspect, the present invention may also be an event prediction program that causes a computer to function as the event prediction device or causes a computer to execute the event prediction method.

### Effects of the Invention

According to the above-described invention, it is possible to efficiently incorporate external information into a point process model of events and predict an event with high accuracy.

### BRIEF DESCRIPTION OF DRAWINGS

FIG. 1 is a block diagram of an event prediction device, which is one aspect of the present invention.

FIG. 2 is a flowchart showing learning and event prediction steps performed by the event prediction device shown in FIG. 1.

FIG. 3 is one example of event history information stored in an event history storage device.

FIG. 4 is one example of external information stored in an external information storage device.

### DESCRIPTION OF EMBODIMENTS

The following describes an embodiment of the present invention with reference to the drawings, but the present invention is not limited to this embodiment.

[Summary]

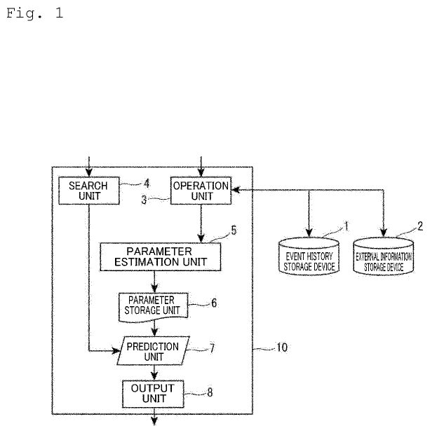

An event prediction device 10 shown in FIG. 1 predicts an event in the near future while taking the influence of external factors into consideration by extending a point process model of events such that the influence of external factors can be learned.

Examples of events include a history of crimes happened in a city, a taxi boarding/alighting history, and a history of automobile accidents, and each event is expressed by a point in time and a place at which the event has occurred.

[Exemplary Aspect of Device]

The event prediction device 10 includes an operation unit 3, a search unit 4, a parameter estimation unit 5, a parameter storage unit 6, a prediction unit 7, and an output unit 8. These functional units are realized by hardware resources of a computer. That is, the event prediction device 10 at least includes computer-related hardware resources such as an arithmetic device (CPU), a storage device (a memory, a hard disk device, etc.), and a communication interface. As a result of these hardware resources cooperating with software resources (OS, applications, etc.), each functional unit is implemented. Note that the functional units may also be individually implemented by individual computers.

The following describes specific exemplary aspects of the functional units of the event prediction device 10.

The operation unit 3 accepts various kinds of operations with respect to data in the event history storage device 1 and the external information storage device 2. The various kinds of operations mean operations such as registering, correction, and deletion of the data. The operation unit 3 is realized through cooperation between an input device such as a keyboard, a mouse, or a touch panel, and control software such as a device driver, a menu screen, or the like.

History information regarding events that can be analyzed by the event prediction device 10 is stored in the event history storage device 1. In response to a request from the operation unit 3 of the event prediction device 10, the history information is extracted from the event history storage device 1 and is supplied to the parameter estimation unit 5 of the event prediction device 10. Exemplary aspects of the event history storage device 1 include a web server that holds a web page and a database server that includes a database.

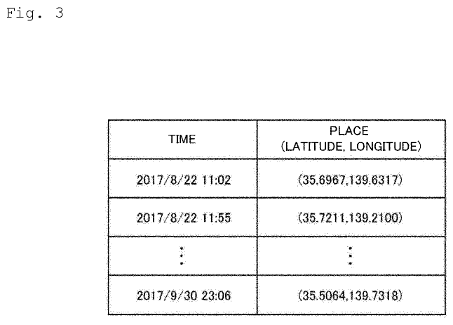

History information shown in FIG. 3 includes time information (date and time of occurrence) and position information (latitude and longitude of a place of occurrence) regarding events. The history information is a taxi boarding history xᵢ or a history xi of crimes happened in a city, for example, is defined by a combination of a point in time tᵢ of occurrence and a place (latitude and longitude) si of occurrence, and is expressed as xᵢ=(tᵢ, sᵢ)^{N}ᵢ₌₁, (tᵢ, sᵢ) ∈ T×S ∈ R×R².

If external information is provided together with a history of N events, the external information is expressed by variables that are associated with weather, events such as a concert and a baseball game, roadwork, a point in time tᵢ of occurrence, and a place (latitude and longitude) sᵢ of occurrence.

External information that can be analyzed by the event prediction device 10 is stored in the external information storage device 2. In response to a request from the operation unit 3 of the event prediction device 10, the external information is extracted from the external information storage device 2 and is supplied to the parameter estimation unit 5 of the event prediction device 10. Similarly to the event history storage device 1, exemplary aspects of the external information storage device 2 include a web server that holds a web page and a database server that includes a database.

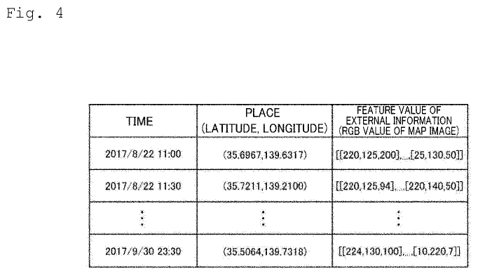

External information shown in FIG. 4 includes external factors that affect the occurrence of an event. External information is data regarding external factors that affect the probability of the occurrence of an event, examples of the external factors including weather, events such as a concert and a baseball game, and roadwork, and the external information is expressed by a set of variables defined by T×S.

To define external information, representative points in time and space are defined. Here, J representative points {uⱼ}^{J}ⱼ₌₁ are introduced. Each representative point is expressed by a pair (uⱼ=(τⱼ, ζⱼ)) of a point in time τⱼ ∈ T and a place ζⱼ ∈ S.

A feature vector zⱼ of external information is associated with each representative point uⱼ. For example, a feature vector of a map image of a geographical space area is defined as {Iⱼ}^{j}ⱼ₋₁, Iⱼ ∈ R^{Nh×N}^{_{W}}^{×N}^{_{C}}. Nh represents the height of the image, N_{W} represents the width of the image, and N_{C} represents an image feature value such as an RGB value. A feature vector of a sentence regarding an event such as a concert or roadwork is defined as {Wⱼ}^{j}ⱼ₌₁, Wⱼ ∈ R^{N}^{_{S}}^{×N}^{_{V}}. represents the length of the sentence and N_{V} represents the number of vocabulary words. At this time, the feature vector zⱼ is expressed by a pair (Iⱼ, Wⱼ) of an image feature value and a sentence feature value.

The search unit 4 accepts information regarding a point in time and a position for which prediction is to be performed. The search unit 4 is realized through cooperation between an input device, such as a keyboard, a mouse, or a touch panel, that is operated by a user who performs prediction of an event and control software such as a device driver, a menu screen, or the like.

The parameter estimation unit 5 estimates an optimum parameter for prediction of an event by supplying event history information stored in the event history storage device 1 and external information stored in the external information storage device 2 to learning of a relationship between a point process model of events and external factors.

The point process model is expressed by a function that is called an intensity function. The intensity function is a function that indicates a probability as to when and where an event occurs, and is expressed by a sum total of products of a kernel function and a deep learning model.

In particular, the intensity function of this aspect incorporates the influence of the above-described external information. Also, the above-described history information is considered in evaluation of the intensity function. That is, position information regarding representative points corresponding to the external information is supplied as a parameter of the kernel function of the intensity function. The position information regarding the representative points and the external information are supplied as parameters of the deep learning model of the intensity function. The history information is supplied as a parameter of a likelihood function of the intensity function. Then, parameters (position information regarding a specific representative point and external information) of the deep learning model with which a likelihood computed using the likelihood function becomes the maximum are estimated as optimum parameters for prediction of an event.

The optimum parameters obtained by the parameter estimation unit 5 are stored in the parameter storage unit 6. The parameter storage unit 6 is not particularly limited so long as the optimum parameters can be stored and restored, and is implemented in a database or a specific region of a general-purpose storage device (a memory, a hard disk device, etc.) provided in advance, for example.

The prediction unit 7 accepts, from the search unit 4, time information and position information for which prediction is to be performed, and predicts an event in the near future. In this prediction, an event is predicted by supplying the time information and the position information for which prediction is to be performed, to the intensity function to which the optimum parameters for prediction of an event are introduced from the parameter storage unit 6.

The output unit 8 outputs an event obtained by the prediction unit 7. The output in this aspect is not limited to output to an output device of a computer, such as a display or a speaker, but also includes printing performed using a printer, transmission to an external device via a network, and the like. The output unit 8 is realized through cooperation between an output device of a computer and driver software of the output device.

[Description of Operation Example]

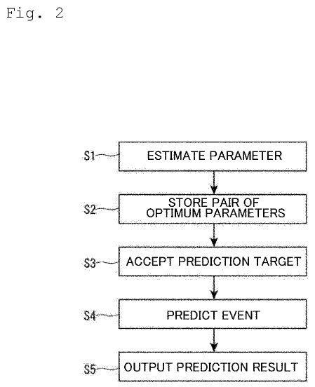

An operation example of the event prediction device 10 according to the present embodiment will be described with reference to FIGS. 1 and 2.

(Learning Steps for Event Prediction)

S1: The parameter estimation unit 5 estimates an optimum parameter for prediction of an event by learning a relationship between event data and external factors based on event history information extracted from the event history storage device 1 and external information extracted from the external information storage device 2.

When position information U={uⱼ}^{J}ⱼ₌₁ regarding representative points corresponding to a sequence Z={zⱼ}^{J}ⱼ₌₁ of the above-described external information is used as a parameter, an intensity function is expressed as a deep mixture model of a kernel function defined by the following expression (1).

$$\begin{matrix}[ Formula 1 ] & \\ λ ( x \vert Z ) = {\sum }_{j = 1}^{J} f ( {u}_{j} , {z}_{j} ) k ( x , {u}_{j} ) & ( 1 )\end{matrix}$$

In the expression (1), k(x, uⱼ) represents a kernel function that is centered on the position uⱼ of a representative point. x represents a pair of time information (date and time) and position information (latitude and longitude) for which prediction is to be performed. f (uⱼ, zⱼ) represents a deep learning model that outputs a non-negative scalar. Through this formulation, it is possible to grasp and automatically learn a complex non-linear relationship between external factors and the probability of the occurrence of an event. An error backpropagation method is appropriately applied to this learning step.

Various assumptions can be made regarding the kernel function k(x, uⱼ). For example, commonly used Gaussian kernel is defined by the following expression (2). In the expression (2), a represents an arbitrary constant.

[Formula 2]

k(x, uⱼ)=exp (−a(x−uⱼ)^{T} (x−uⱼ)) (2)

A likelihood function of the expression (1) is expressed by the following expression (3).

$$\begin{matrix}[ Formula 3 ] & \\ \begin{matrix}L = log p ( H \vert λ ( x ) ) = {\sum }_{i = 1}^{N} log λ ( {x}_{i} \vert Z ) - {\int }_{TxS} λ ( x \vert Z ) dx \\ = {\sum }_{i = 1}^{N} log {\sum }_{j = 1}^{J} f ( {u}_{j} , {z}_{j} ; θ ) k ( {x}_{i} , {u}_{j} ) - \\ {\sum }_{j = 1}^{J} f ( {u}_{j} , {z}_{j} ; θ ) {\int }_{TxS} k ( x , {u}_{j} ) dx\end{matrix} & ( 3 )\end{matrix}$$

In the expression (3), θ represents a parameter of a neural network f(uⱼ, zⱼ; θ) of the deep learning model. Since the representative points are introduced in step S2, the neural network f(uⱼ, zⱼ; θ) can be put on the outside of the integral. As a result, the derivative of each variable can be easily computed, and an optimization method, such as an error backpropagation method, in which errors are used can be applied. In the learning, a parameter Θ of the neural network f(uⱼ, zⱼ; Θ) with which a likelihood L computed using the expression (3) becomes the maximum is estimated. This parameter Θ is taken to be the optimum parameter for prediction of an event.

S2: The optimum parameter 8 for prediction of an event obtained in step S2 (parameter estimation unit 5) is stored in the parameter storage unit 6.

The above-described learning steps (S1, S2) are appropriately executed every time history information in the event history storage device 1 or external information in the external information storage device 2 is updated.

(Event Prediction Steps)
S3: The search unit 4 accepts, from a user, time information (e.g., date and time) and position information (e.g., latitude and longitude) for which prediction of an event is to be performed.

S4: The prediction unit 7 predicts an event based on the pair x of the time information and the position information accepted in step S3 (search unit 4). Specifically, an event in the near future is predicted by supplying the pair x of the time information and the position information to the intensity function (expression (1)) to which the optimum parameter 8 extracted from the parameter storage unit 6 is applied. In the prediction, a known simulation method for a point process can be applied. For example, a thinning method disclosed in NPL 3 can be appropriately applied.

S5: The output unit 8 outputs an event that is obtained through the prediction performed in step S4. The event is output to be displayed in a display of the event prediction device 10 or is transmitted to a terminal of the user via a network, for example.

### Effects of Present Embodiment

According to the above-described event prediction device 10, it is possible to predict an event with high accuracy as a result of the complex influence of external information being incorporated into the point process model of events.

In particular, as a result of a relationship between the intensity function expressing the point process model of events and external factors being learned based on event history information and external information, an optimum parameter for prediction of an event is estimated. Also, as a result of a parameter of the deep learning model with which the likelihood of the intensity function becomes the maximum being applied as the optimum parameter, the accuracy of prediction of an event is further enhanced.

### Other Aspects of Invention

Another aspect of the present invention is a program that causes a computer to function as some or all of the above-described functional units of the event prediction device 10. Another aspect of the present invention is a program that causes a computer to execute some or all of the steps of the above-described event prediction method executed by the event prediction device 10. These event prediction programs are provided in a state of being stored in a known computer-readable recording medium or provided via a network such as the Internet.

Note that the above-described invention is not limited to the above-described embodiment, and various changes and applications can be made within the scope of the claims.

### REFERENCE SIGNS LIST

Event history storage device
External information storage device
Operation unit
Search unit
Parameter estimation unit
Parameter storage unit
Prediction unit
Output unit
Event prediction device

1. An event prediction device that predicts an event, comprising:
a parameter estimatorestimation unit configured to estimate an optimum parameter for prediction of an event by supplying event history information and external information to learning of a relationship between a point process model of events and external factors, the event history information including a point in time and a place at which an event has occurred, the external information including an external factor that affects the occurrence of an event.

2. The event prediction device according to claim 1, wherein the point process model is an intensity function that is expressed by a sum total of products of a kernel function and a deep learning model, position information regarding a representative point that corresponds to the external information is supplied as a parameter of the kernel function, the position information regarding the representative point and the external information are supplied as parameters of the deep learning model, and the history information is supplied as a parameter of a likelihood function of the intensity function.

3. The event prediction device according to claim 2, wherein the optimum parameter is a parameter of the deep learning model with which a likelihood that is computed using the likelihood function becomes the maximum.

4. An event prediction method for predicting an event by using a computer, the method comprising:
estimating, by a parameter estimator, an optimum parameter for prediction of an event by supplying event history information and external information to learning of a relationship between a point process model of events and external factors, the event history information including a point in time and a place at which an event has occurred, the external information including an external factor that affects the occurrence of an event.

5. The event prediction method according to claim 4, wherein the point process model is an intensity function that is expressed by a sum total of products of a kernel function and a deep learning model, position information regarding a representative point that corresponds to the external information is supplied as a parameter of the kernel function, the position information regarding the representative point and the external information are supplied as parameters of the deep learning model, and the history information is supplied as a parameter of a likelihood function of the intensity function.

6. A computer-readable non-transitory recording medium storing computer-executable program instructions that when executed by a processor cause a computer system to:
estimate, by a parameter estimator, an optimum parameter for prediction of an event by supplying event history information and external information to learning of a relationship between a point process model of events and external factors, the event history information including a point in time and a place at which an event has occurred, the external information including an external factor that affects the occurrence of an event.

7. The event prediction device according to claim 1, wherein the event includes one or more of:
a crime occurred in a city,
boarding to a taxi, and
an automobile accident.

8. The event prediction device according to claim 1, wherein the external information includes at least a variable associated with one or more of: weather, a concert, a baseball game, a roadwork, time of the event, and the place of the event.

9. The event prediction device according to claim 2, wherein the intensity function indicates a probability as to when and where the event occurs.

10. The event prediction device according to claim 2, wherein the estimator estimates the optimum parameter for prediction of the event subsequent to an update to either the history information or the external information takes place.

11. The event prediction method according to claim 4, wherein the event includes one or more of:
a crime occurred in a city,
boarding to a taxi, and
an automobile accident.

12. The event prediction method according to claim 4, wherein the external information includes at least a variable associated with one or more of: weather, a concert, a baseball game, a roadwork, time of the event, and the place of the event.

13. The event prediction method according to claim 5, wherein the optimum parameter is a parameter of the deep learning model with which a likelihood that is computed using the likelihood function becomes the maximum.

14. The event prediction method according to claim 5, wherein the intensity function indicates a probability as to when and where the event occurs.

15. The event prediction method according to claim 5, wherein the estimator estimates the optimum parameter for prediction of the event subsequent to an update to either the history information or the external information takes place.

16. The computer-readable non-transitory recording medium according to claim 6, wherein the point process model is an intensity function that is expressed by a sum total of products of a kernel function and a deep learning model, position information regarding a representative point that corresponds to the external information is supplied as a parameter of the kernel function, the position information regarding the representative point and the external information are supplied as parameters of the deep learning model, and the history information is supplied as a parameter of a likelihood function of the intensity function.

17. The computer-readable non-transitory recording medium according to claim 6, wherein the event includes one or more of:
a crime occurred in a city,
boarding to a taxi, and
an automobile accident.

18. The computer-readable non-transitory recording medium according to claim 6, wherein the external information includes at least a variable associated with one or more of: weather, a concert, a baseball game, a roadwork, time of the event, and the place of the event.

19. The computer-readable non-transitory recording medium according to claim 16, wherein the optimum parameter is a parameter of the deep learning model with which a likelihood that is computed using the likelihood function becomes the maximum.

20. The computer-readable non-transitory recording medium according to claim 16, wherein the intensity function indicates a probability as to when and where the event occurs.
